(19) United States
(12) Patent Application Publication
(10) Pub. No.: US 2003/0104809 A1
(43) Pub. Date: Jun. 5, 2003

(54) Local wireless network system for cellular telephones

(75) Inventors: Donald E. Godshaw, Evanston, IL (US); Jon O. Nelson, Evanston, IL (US); Kenneth F. Smolik, Naperville, IL (US)

Correspondence Address: BANNER & WITCOFF, LTD., TEN SOUTH WACKER DRIVE, SUITE 3000, CHICAGO, IL, 60606, US

(73) Assignee: Donald E. Godshaw, Evanston, IL

(21) Appl. No.: 10/298,787

(22) Filed: Nov. 18, 2002

Related U.S. Application Data
(60) Provisional application No. 60/337,583, filed on Dec. 5, 2001.

(51) Int. Cl. H04M 3/00; H04Q 7/20

(52) U.S. Cl. 455/426; 455/435; 455/418

(57) ABSTRACT

The present invention is a wireless network system, which comprises at least one wireless instrument (e.g. a cellular telephone) in combination with at least one cradle (e.g. a telephone cradle), said cradle comprising a wireless local area network (WLAN) interface. The WLAN interface, which interfaces to a WLAN, allows the cradle to communicate with a controller. In turn, the controller communicates with a base station of a wireless communications network. In a variation of the exemplary embodiment, a wired local area network (LAN) can be utilized rather than the WLAN. Alternatively, the present invention supports point-to-point communication configurations between each wireless cellular telephone and the controller. Typically, the base station is owned and operated by wireless service provider. The wireless service provider directly supports service for the wireless cellular telephone when the telephone is not operating in conjunction with the wireless network system.

This application claims priority to provisional U.S. Provisional Patent Application No. 60/337,583 (“A Local Wireless Network System for Cellular Telephones”), filed Dec. 5, 2001.

### FIELD OF THE INVENTION

The present invention relates to networking wireless cellular telephones with a controller.

### BRIEF SUMMARY OF THE INVENTION

Briefly, the present invention is a wireless network system, which comprises a least one wireless instrument (e.g. a wireless cellular telephone) in combination with at least one cradle (e.g. a telephone cradle), said cradle comprising a wireless local area network (WLAN) interface. The WLAN interface, which interfaces to a WLAN, allows the cradle to communicate with a controller. In turn, the controller communicates with a base station of a wireless communications network. In a variation of the exemplary embodiment, a wired local area network (LAN) can be utilized rather than the WLAN. Alternatively, the present invention supports point-to-point communication configurations between each wireless cellular telephone and the controller. Typically, the base station is owned and operated by wireless service provider. The wireless service provider directly supports service for the wireless cellular telephone when the telephone is not operating in conjunction with the wireless network system.

The system contemplates two or more wireless cellular telephones, each wireless cellular telephone having its own wireless telephone number and two or more cradles for receipt, each cradle adapted to receive a wireless cellular telephone. Each cradle includes an electrical connection for charging the wireless cellular telephone as well as a telephone jack connection and means to integrate the wireless cellular telephone into a local area network comprising wireless cellular telephones and compatible cradles. One or more cradles may act as a controller for the local area network.

Generally each of the wireless cellular telephones shall be subscribed in the same network; however, multiple networks may be accommodated by the system when the home site controller is utilized to control the local area network. Thus, the home site controller in such circumstances enables use of multiple subscribers to multiple networks.

The embodiment of the invention may support different wireless services that encompass voice services and data services, and thus may support voice calls, data calls, and calls that integrate both voice and data services.

Various variations of the exemplary embodiment are disclosed including:

1. A system where one or more of the cellular telephones communicates directly with a remote base station for outgoing calls only;

2. A system where one or more of the cellular telephones connects with the wireless local area network only with respect to incoming calls;

3. A system where one or more of the cellular telephones connects with the wireless local area network when the cellular telephone is within a proscribed proximity of the wireless local area network;

4. A system where one or more of the cellular telephones connects with the wireless local area network only upon mechanical and/or electrical engagement of the cellular telephone with an element of the wireless local area network;

5. A system wherein one or more cellular telephones communicates through a controller of the wireless local area network for outgoing calls when the cellular telephone has been integrated mechanically, electrically, or by proximity into the wireless local area network;

6. A system wherein at least two individual wireless cellular telephones communicate wirelessly via a base station for outgoing calls and via said base station for incoming calls through any one of a plurality of cradles provided at said home site provided that the wireless cellular telephone has mechanically, electronically or by virtue of proximity been linked to the cradle;

7. A system wherein at least two individual wireless cellular telephones in any of the previously described systems:

(a) communicate directly and wirelessly through a local area network at the home site

(b) indicate via indicator or sensor on the wireless cellular telephone about

(i) available lines in use and/or

(ii) unavailable lines in use

(c) incorporate speaker telephone capability via one or more cradles at a home site

(d) employ controls on the wireless cellular telephone or cradle to lock out participation by the wireless cellular telephone in the system or lock out audio ringing of the wireless cellular telephone; and

8. A variation of the embodiment wherein a controller and a wireless instrument each supports a wireless network interface. With the variation of the embodiment, the wireless instrument communicates directly with the controller.

### BRIEF DESCRIPTION OF THE DRAWINGS

FIG. 1 shows an architecture for a local wireless network system in accordance with the present invention;

FIG. 2 shows a second architecture for a local wireless network system;

FIG. 3 is a flow diagram for registering a wireless cellular telephone with a local wireless network system; and

FIG. 4 is a flow diagram for processing an incoming call to a local wireless network system.

### DETAILED DESCRIPTION OF THE INVENTION

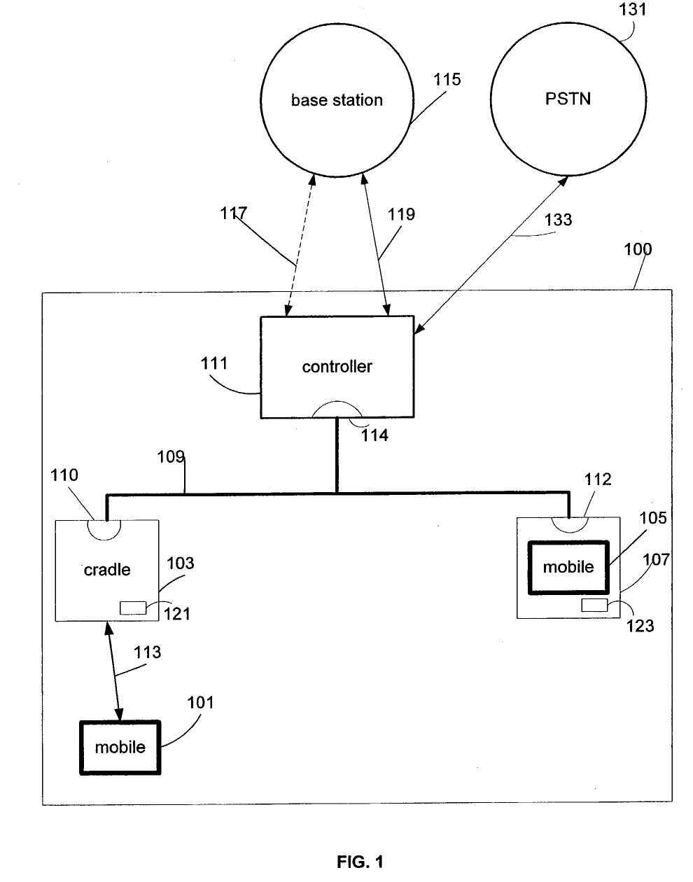

FIG. 1 illustrates an architecture of wireless network system 100 in accordance with the present invention. Wireless network system 100 comprises wireless instruments (e.g. cellular telephones) 101 and 105, cradles 103 and 107, wireless local area network (WLAN) 109, and controller 111. Wireless cellular telephone 101 communicates with cradle 103 through a cordless telephone channel 113. Wireless cellular telephones 101 and 105 can operate outside wireless network system 100 in which the wireless cellular telephones communicate directly with base station 115 over control radio channel 117 and traffic radio channel 119. However, when wireless cellular telephones are operating within wireless network system 100, controller 111 communicates over control radio channel 117 and traffic radio channel 119 in order to provide service for the wireless cellular telephones.

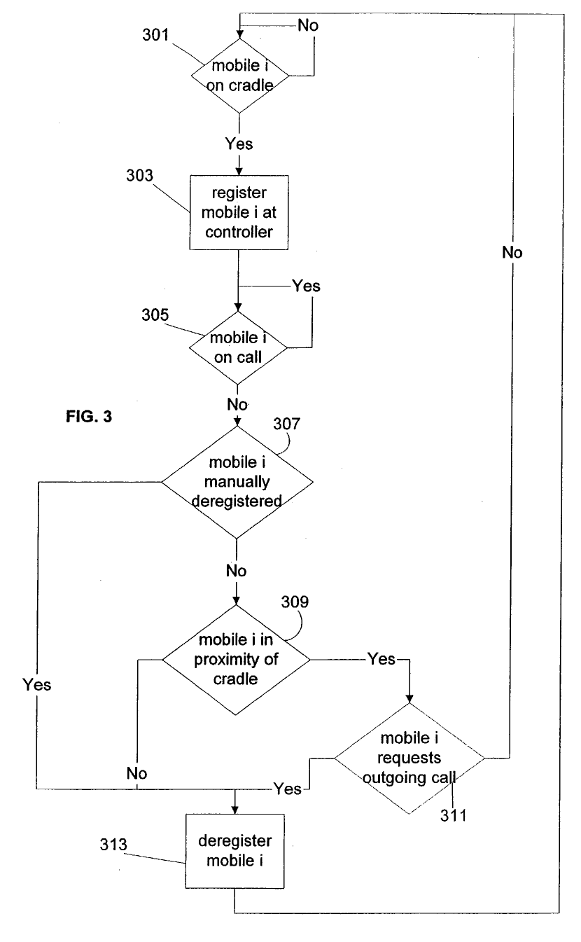

A sensor in cradle 103 or 107 detects when wireless cellular telephone 101 or 105 is situated in a cradle, thus causing a message to be sent from the cradle to controller 111 over wireless local area network (WLAN) 109 through WLAN interfaces 110, 112, and 114. (The message notifies controller 111 of the presence of wireless cellular telephone 103 or 107 in accordance with a registration procedure that is discussed with FIG. 3.) WLAN 109 can assume different configurations including IEEE (Institute of Electrical and Electronics Engineers) 802.11 wireless local area network and HomeRF Working Group's Shared Wireless Access Protocol (SWAP). Alternatively, WLAN 109 can be replaced by a wired configuration such as existing telephone wiring in the house.

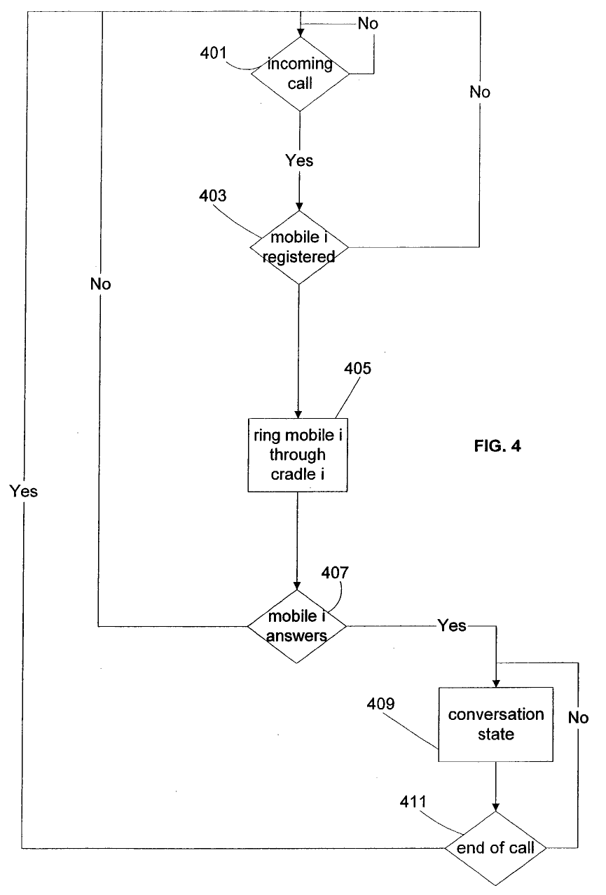

When wireless cellular telephone 101 or 105 is registered at controller 111, communications between base station 115 and the wireless cellular telephone is processed through controller 111 as discussed in the context of FIGS. 3 and 4. (When a wireless cellular telephone is registered with controller 111, the wireless cellular telephone is referred as being in the “local mode”; otherwise, the wireless cellular telephone is referred as being in the “normal mode.”) For example, with any incoming calls for wireless cellular telephone 101 or 105 (when registered with controller 111), controller 111 processes control radio channel 117 for paging the wireless cellular telephone and processes traffic radio channel 119 for transporting user information. User information can include voice information or data information or both. When wireless cellular telephone 101 or 105 is in the local mode, any paging message (over control radio channel 117) that identifies the telephone number of the wireless cellular telephone is recognized by controller 111 as an incoming call for the registered wireless cellular telephone 101 or 105. Consequently, controller 111 generates a message to all registered wireless cellular telephone through the corresponding cradles in order to alert all the registered wireless cellular telephones. Wireless cellular telephone 101 is alerted through cordless radio channel 113. As an example, if wireless cellular telephone 101 is paged and wireless cellular telephones 101 and 105 are registered, controller 111 alerts both wireless cellular telephones 101 and 105 of the incoming call. When either wireless cellular telephone 101 or 105 answers the incoming call, a message is sent to controller 111 over WLAN 109 to establish the call to base station 115 over traffic radio channel 119. Once the call is established, messaging carries user information (such a voice information) that is sent over WLAN 109 to complete the call to the wireless cellular telephone.

The present invention can supports a plurality of traffic radio channels so that a plurality of simultaneous calls can occur at the same time for a plurality of registered wireless cellular telephone such 101 and 105. As an example, wireless cellular telephone 101 may be communicating with one external telephone while wireless cellular telephone 105 may be communicating with a second external telephone at a given instance of time. Moreover, the present invention can support vertical services such as conferencing, call forwarding, and speed dialing as well as other local services such as intercom.

In the exemplary embodiment, when wireless cellular telephone 101 or 105 requests for an outgoing call, the wireless cellular telephone is de-registered (as discussed in FIG. 3), and the wireless cellular telephone operates in the normal mode (i.e. a outgoing call is established directly between the wireless cellular telephone and base station 115). However, the present invention supports variations of the embodiment in which the wireless cellular telephone remains in the local mode. In such cases, wireless cellular telephone 101 or 105 sends a request for an outgoing call through WLAN 109 to controller 111. Consequently, controller 111 establishes a call over traffic radio channel 119, utilizing control radio channel 117.

Controller 111 can interface to public switching telephone network (PSTN) 131 through line 133 in order to support the convergence of wireless and wireline services. If wireless cellular telephone 101 or 105 is registered with controller 111, a call with a wireless cellular telephone and PSTN 131 can be established.

Indicators 121 and 123 provide an indication of whether wireless cellular telephone 101 and 105 are in the local mode or in the normal mode. Moreover, indicators 121 and 123 can provide status of other wireless cellular telephones.

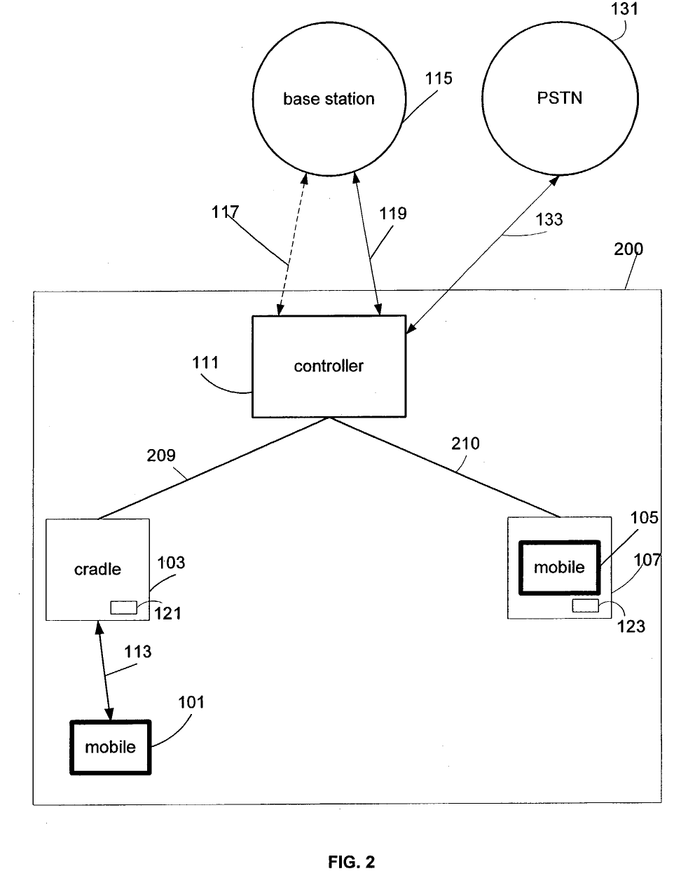

FIG. 2 shows a second architecture of wireless network system 200. FIG. 2 is differentiated from FIG. 1 in that WLAN 109 is replaced by a point-to-point configuration comprising link 209 and 210. The point-to-point configuration can assume different configurations, including a wired configuration or a wireless configuration such as a configuration in accordance with the Bluetooth specification.

FIG. 3 shows a flow diagram for registering wireless cellular telephone (mobile) 101 or 105 with controller 111. In step 301, wireless cellular telephone 101 or 105 is placed into cradle 103 or 107. The cradle detects the presence of the wireless cellular telephone through a mechanical or electrical contact. If this is the case, the wireless cellular telephone is registered with controller 111 in step 303. When a wireless cellular telephone registers, the corresponding telephone number of the wireless cellular telephone and the corresponding cradle is recorded. Step 305 determines if the wireless cellular telephone is currently on a call. If so, the wireless cellular telephone cannot be de-registered. If the wireless cellular telephone is not active with a call, then the wireless cellular telephone can be de-registered (as in step 313) by the user manually de-registering the wireless cellular telephone in step 307. Also, if the wireless cellular telephone is not in the proximity of the corresponding cradle the wireless cellular telephone is de-registered in step 309. In step 311, if the wireless cellular telephone requests an outgoing call, the wireless cellular telephone is de-registered. In other words, the wireless cellular telephone operates in the normal mode for outgoing calls. However, other variations of the embodiment support outgoing calls in which the wireless cellular telephone operates in the local mode. Typically, the process, as depicted by the flow diagram in FIG. 3, is implemented in controller 111.

FIG. 4 shows a flow diagram for processing an incoming call. However, the present invention can support a plurality of simultaneous incoming calls if controller 111 supports a plurality of traffic radio channels. In step 401, controller 111 receives notification of an incoming call over control radio channel 117. In step 403, controller 111 determines if the wireless cellular telephone is registered. If so, the wireless cellular telephone is alerted through the corresponding cradle over the cordless telephone channel in step 405. In step 407, if the wireless cellular telephone is the first wireless cellular telephone to answer, an incoming call is established to the wireless cellular telephone. Otherwise, the process returns to step 401. The call is established in the conversation state in step 409 in which user information is transported on WLAN 109 or links 209 and 210. User information can correspond to voice, data, or a combination of both. In step 411, if the end of the incoming call is detected. The process returns to step 401.

The embodiment of the invention may support different wireless services that encompass voice services and data services, and thus may support voice calls, data calls, and calls that integrate both voice and data services.

With a variation of the embodiment, a controller and a wireless instrument each supports a wireless network interface. The wireless instrument communicates directly with the controller so that a cradle for the wireless instrument may not be required in the configuration.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

It is to be understood that the above-described embodiment is merely an illustrative principle of the invention and that many variations may be devised by those skilled in the art without departing from the scope of the invention. It is, therefore, intended that such variations be included with the scope of the claims.

We claim:

1. A wireless network system for supporting at least one wireless instrument, the wireless network system comprising:
a local network;
a first cradle that holds a first wireless instrument and that communicates with the first wireless instrument over a first local wireless channel when the first wireless instrument functions in a local mode state; and
a controller that connects to the first cradle through the local network in order to communicate with the first wireless instrument when the first wireless instrument is engaged with the first cradle and that communicates with a base station over a first radio channel, wherein the base station provides wireless service for the first wireless instrument.

2. The wireless network system of claim 1, wherein the first wireless instrument is engaged with the first cradle corresponding to an occurrence selected from the group consisting of a mechanical engagement with the first cradle, an electrical engagement with the first cradle, and being located in close proximity to the first cradle.

3. The wireless system of claim 1, further comprising:
a second cradle that holds a second wireless instrument and that communicates with the second wireless instrument over a second local wireless channel when the second wireless instrument functions in the local mode state.

4. The wireless network system of claim 1, wherein the controller interfaces to a public switching telephone network (PSTN).

5. The wireless network system of claim 1, wherein the local network comprises a wireless local area network (WLAN).

6. The wireless network system of claim 5, wherein the WLAN supports a specification selected from the group consisting of Institute of Electrical and Electronics Engineers (IEEE) 802.11 and HomeRF Working Group's Shared Wireless Access Protocol (swap).

7. The wireless network system of claim 1, wherein the local network supports a point-to-point configuration.

8. The wireless network system of claim 7, wherein the point-to-point configuration is supported in accordance with a Bluetooth specification.

9. The wireless network system of claim 1, wherein the local network comprises a wired configuration.

10. The wireless network system of claim 1, wherein the controller determines that the first wireless instrument is functioning in the local mode state when the first wireless instrument is registered with the controller.

11. The wireless network system of claim 10, wherein the controller de-registers the first wireless instrument.

12. The wireless network system of claim 1, wherein the first wireless instrument and the second wireless instrument communicate with each other through the local network in order to support a wireless service.

13. The wireless network system of claim 3, wherein the second wireless instrument communicates with the first cradle through a third local wireless channel.

14. The wireless network system of claim 1, wherein the controller communicates with the base station over a second radio channel in order to support simultaneous calls.

15. The wireless network system of claim 1, wherein the first cradle recharges a battery of the first wireless instrument.

16. The wireless network system of claim 1, wherein the first wireless instrument is selected from the group consisting of a wireless telephone, a computer, and a personal digital assistant.

17. A method for networking a plurality of wireless instruments through a local network in order to support wireless service for the plurality of wireless instruments, the wireless service being supported by a base station, the method comprising:
(a) registering a first wireless instrument of the plurality of wireless instruments at a controller of the local network;
(b) receiving an indicator of an incoming call for one of the plurality of wireless instruments;
(c) in response to receiving an indicator of the incoming call, initiating ringing at the first wireless instrument;
(d) if the first wireless instrument goes off hook before the other wireless instruments of the plurality of wireless instruments, completing the incoming call to the first wireless instrument.

18. The method of claim 17, further comprising:
(e) in response to (b), if a second wireless instrument is de-registered, not initiating ringing at the second wireless instrument.

19. The method of claim 17, wherein (a) comprises:
if the first wireless instrument is engaged with a first cradle, registering the first wireless instrument.

20. The method of claim 17, wherein (a) comprises:
if the first wireless instrument requests to be de-registered; de-registering the first wireless instrument.

21. The method of claim 17, wherein (a) comprises:
if the first wireless instrument is not in close proximity to a cradle, de-registering the first wireless instrument.

22. The method of claim 17, wherein (a) comprises:
if the first wireless instrument requests an outgoing call, de-registering the first wireless instrument.

23. A wireless instrument that interacts with a wireless network system in order to support wireless services with a base station, the wireless instrument comprising:
a radio channel module that communicates with the base station over a radio channel in order to support the wireless services when the wireless instrument is functioning in a normal mode state;
a local wireless module that communicates with the wireless network system through a local network over a local wireless channel in order to support the wireless services when the wireless instrument is functioning in a local mode state; and
a processor that determines to activate the local wireless module when functioning in the local mode state, the processor configured to perform the steps of:
(a) registering with the wireless network system;
(b) receiving an instruction to initiate ringing in response to a delivery attempt of an incoming call;
(c) completing the incoming call with the wireless network system through the local wireless module; and
(d) if the wireless instrument enters into the normal mode state, de-registering with the wireless network system.

24. The wireless instrument of claim 23, further comprising:
a display module that indicates whether the wireless instrument is functioning in either the local mode state or the normal mode state.

25. A wireless network controller for supporting at least one wireless instrument, the wireless network controller comprising:
a radio module that communicates with a base station over a radio channel;
a wireless network module that communicates with a wireless instrument, wherein the wireless instrument is one of the at least one wireless instrument; and
a processor that interfaces with the radio module and the wireless network module, the processor configured to perform the steps of:
(a) registering the wireless instrument through the local network module;
(b) receiving an indicator of an incoming call for the wireless instrument;
(c) in response to step (a) and step (b), sending an instruction to initiate ringing for a delivery attempt of the incoming call;
(d) completing the incoming call with the wireless terminal through the local network module; and
(e) in response to determining that the wireless instrument is not functioning in a local mode state, de-registering the wireless instrument.
